(19) United States
(12) Patent Application Publication
(10) Pub. No.: US 2018/0285399 A1
(43) Pub. Date: Oct. 4, 2018

(54) SYSTEMS AND METHODS FOR QUERY AND INDEX OPTIMIZATION FOR RETRIEVING DATA IN INSTANCES OF A FORMULATION DATA STRUCTURE FROM A DATABASE

(71) Applicant: American Chemical Society, Washington, DC (US)

(72) Inventors: Elizabeth Michele ALTIZER, Columbus, OH (US); Patrick Neil KENNEDY, Columbus, OH (US); Scott Matthew COPLIN, Columbus, OH (US); Brian Walter LINK, Delaware, OH (US); Susan Ellen MILLER, Columbus, OH (US); Pillhun SON, Columbus, OH (US); Matthew James TOUSSANT, Columbus, OH (US); Amanda Brooke WINDHOF, Columbus, OH (US); Jeffery D. WISARD, Lewis Center, OH (US)

(73) Assignee: American Chemical Society, Washington, DC (US)

(21) Appl. No.: 15/944,573

(22) Filed: Apr. 3, 2018

Related U.S. Application Data
(60) Provisional application No. 62/481,076, filed on Apr. 3, 2017.

(51) Int. Cl. G06F 17/30

(52) U.S. Cl. CPC G06F 17/30336; G06F 17/30442; G06F 17/30533

(57) ABSTRACT

Systems and methods are provided for query and index optimization for retrieving data in instances of a formulation data structure from a database. The methods include presenting an information source for searching for the presence of formulations and generating formulation data from field entries. The formulation data is associated with found formulations. The methods include generating an instance of a formulation data structure. The instance of the formulation data structure associates the information source with the found formulations. The methods include creating optimized index data from retrieved data in the instance of the formulation data structure. The optimized index data includes a mapping between potential search-field terms and the formulation data, and is grouped based on a predicted access pattern. The methods include running a search query across the optimized index data and providing information associated with an information source associated with retrieved data in an instance of a formulation data structure.

### PRIORITY CLAIM

This application claims priority from U.S. Provisional Patent Application No. 62/481,076, filed Apr. 3, 2017, which is hereby incorporated by reference in its entirety in the present application.

### TECHNICAL FIELD

The present disclosure provides systems and methods for query and index optimization. In particular, in some embodiments, the systems and methods for query and index optimization may pertain to retrieving data in instances of a formulation data structure from a database.

### BACKGROUND

A formulation is a combination of multiple components. Such components may be materials, compounds and/or substances that are used for specific purposes. For example, formulations may include a combination of one or more active ingredients (e.g., a pharmaceutical, pesticide, or fertilizer) and one or more inert components. The inert components may facilitate the efficacy of the active ingredients, their application, storage, or safety. For example, a formulation may be a baked cake consisting of multiple ingredients. In other examples, a formulation may be a polymer or a mixture of materials. Formulations may be relevant to the fields of chemistry, agrochemicals, pharmaceuticals, biotechnology, life sciences, manufacturing, cosmetics, health, food and beverage, consumer goods, paints and coatings, polymers, plastics, rubber, petroleum, gas, metals, alloys, cement, automotive, aerospace, defense, etc.

Formulations may be disclosed in information sources. Information sources may be, for example, documents, published works, package inserts, research papers, patents, patent applications, advertisements, presentations, websites, and/or journals. Information sources disclosing formulations may be publicly available or stored in private collections.

Users may search for disclosures of formulations in electronically stored information sources. For example, users may search using text-based searching. A user may attempt a search for a formulation name to find information sources that contain the formulation's name. If a user wants to find electronically stored disclosures of formulations that have two compounds, the user may attempt a search for the two compounds by name to find information sources that contain the two compounds' names. In some cases, however, the user may be presented with information sources that mention both compounds but in unrelated contexts. As a result, some of the discovered information sources may lack a formulation that comprises both compounds. In some instances, the user may be presented with information sources that mention both compounds in a related context but where, nevertheless, no formulation comprises both compounds. For example, an information source may describe a formulation containing one of the searched compounds but the other searched compound may be mentioned in the information source as an alternative to the former compound.

Additionally, while some information sources containing a formulation may provide various pieces of information of interest to users searching for the formulation, they may fail to explicitly disclose some other information of interest. For example, the purpose of a formulation may be described but the formulation target may be omitted. Mention of the target may be omitted because the author believes it to be implicitly disclosed or clear enough from the context not to require explicit disclosure. In some instances, authors may purposely obfuscate information (e.g., in a patent application) to limit public disclosure.

Further, some formulations may be unamenable to identification by regular text-based descriptions such as a formulation's name. This may occur, for example, when a formulation does not have a name or a formulation's name is very complicated. Sometimes it may be easier to identify a formulation with, for example, a registry number (e.g., a CAS Registry Number® such as “329-65-7”), an identifier (e.g., “1/C2H6O/c1-2-3/h3H,2H2,1H3”), a chemical connection table, a specific numeric property value (e.g., at 300K, 1.2 mPa·s), or a structure diagram. Conventional internet search engines may not support information-source searches with search fields and queries particular to the field of chemistry or other technical fields. For example, even if a conventional internet search engine allows one to search for information sources containing a substance's name in order to find formulations containing the substance, the conventional internet search engine may lack the ability to allow a user to search for information sources using a query specifying parameters related to the substance. One example of such a query may be for substances with a certain property, such as a boiling point above a certain temperature. A conventional internet search engine may lack the ability to run such a search, in part, because an information source containing a substance by name may never indicate the substance's boiling point. Even if some conventional internet search engines allow searches with search fields and queries particular to the field of chemistry or other technical field, they may lack the ability to create search queries that encompass relationships between different materials, compounds, and substances (e.g., the relationship of being contained within a single formulation).

In addition, existing systems and methods of generating indexes for searching for formulations or information sources containing formulations may generate an index that cannot be searched as efficiently as an index optimized for responding to queries requesting retrieval of information pertaining to formulations or information sources containing formulations. The absence of a data structure designed to optimize query processing and generating optimized indexes further contributes to the inefficiency of existing systems and methods.

The disclosed systems and methods are directed to overcoming one or more of the problems set forth above and/or other problems or shortcomings in the prior art.

### SUMMARY

Consistent with disclosed embodiments, the present disclosure is directed to system and methods for query and index optimization for retrieving data in instances of a formulation data structure from a database.

Consistent with at least one embodiment, a computer-implemented system for query and index optimization for retrieving data in instances of a formulation data structure from a database is disclosed. The system may comprise a memory device that stores a set of instructions and at least one processor that executes the set of instructions to perform a method. The method may comprise presenting an information source for searching for the presence of one or more formulations. The method may comprise generating formulation data from field entries. The formulation data may be associated with one or more found formulations. The method may comprise generating an instance of a formulation data structure. The instance of the formulation data structure may associate the information source with the one or more found formulations. The method may comprise creating optimized index data from retrieved data in the instance of the formulation data structure. The optimized index data may comprise a mapping between one or more potential search-field terms and the formulation data. The optimized index data may be grouped based on a predicted access pattern. The method may comprise running a search query across the optimized index data. The method may comprise providing information associated with a found information source associated with retrieved data in an instance of a formulation data structure. The optimized index data may be an inverted index. The optimized index data may be grouped based on a predicted access pattern such that a search engine's access time of the optimized index data is decreased. The formulation data may comprise component data associated with one or more components. The component data may comprise substance data associated with one or more substances. The substance data may comprise at least one of a registry number, an identifier, a chemical connection table, a structure diagram, or a specific numeric property value. The method may comprise presenting alternate-search statistics. The method may comprise assigning a relevancy weight to the found information source. The search query may comprise one or more search terms associated with one or more search fields. The one or more search fields may pertain to a scientific field. The one or more formulations may be chemical formulations. The retrieved data in an instance of the formulation data structure associated with the found information source may be associated with a formulation identifier.

Consistent with at least one embodiment, a non-transitory computer-readable medium storing a set of instructions that are executable by at least one processor to perform a method for query and index optimization for retrieving data in instances of a formulation data structure from a database is disclosed. The method may comprise presenting an information source for searching for the presence of one or more formulations. The method may comprise generating formulation data from field entries. The formulation data may be associated with one or more found formulations. The method may comprise generating an instance of a formulation data structure. The instance of the formulation data structure may associate the information source with the one or more found formulations. The method may comprise creating optimized index data from retrieved data in the instance of the formulation data structure. The optimized index data may comprise a mapping between one or more potential search-field terms and the formulation data. The optimized index data may be grouped based on a predicted access pattern. The method may comprise running a search query across the optimized index data. The method may comprise providing information associated with a found information source associated with retrieved data in an instance of a formulation data structure. The optimized index data may be an inverted index. The optimized index data may be grouped based on a predicted access pattern such that a search engine's access time of the optimized index data is decreased. The formulation data may comprise component data associated with one or more components. The component data may comprise substance data associated with one or more substances. The substance data may comprise at least one of a registry number, an identifier, a chemical connection table, a structure diagram, or a specific numeric property value. The method may comprise presenting alternate-search statistics. The method may comprise assigning a relevancy weight to the found information source. The search query may comprise one or more search terms associated with one or more search fields. The one or more search fields may pertain to a scientific field. The one or more formulations may be chemical formulations. The retrieved data in an instance of the formulation data structure associated with the found information source may be associated with a formulation identifier.

Consistent with at least one embodiment, a method for query and index optimization for retrieving data in instances of a formulation data structure from a database is disclosed. The method may comprise presenting an information source for searching for the presence of one or more formulations. The method may comprise generating formulation data from field entries. The formulation data may be associated with one or more found formulations. The method may comprise generating an instance of a formulation data structure. The instance of the formulation data structure may associate the information source with the one or more found formulations. The method may comprise creating optimized index data from retrieved data in the instance of the formulation data structure. The optimized index data may comprise a mapping between one or more potential search-field terms and the formulation data. The optimized index data may be grouped based on a predicted access pattern. The method may comprise running a search query across the optimized index data. The method may comprise providing information associated with an information source associated with retrieved data in an instance of a formulation data structure.

The foregoing general description and the following detailed description are exemplary and explanatory only and are not restrictive of the claims.

### BRIEF DESCRIPTION OF THE DRAWINGS

The accompanying drawings, which are incorporated in and constitute part of this specification, together with the description, illustrate and serve to explain the principles of various example embodiments and aspects. In the drawings:

FIG. 1 is an exemplary information flow diagram for query and index optimization for retrieving data in instances of a formulation data structure from a database;

FIG. 2 is an exemplary system environment in which a system for query and index optimization for retrieving data in instances of a formulation data structure from a database may operate;

FIG. 3 is an exemplary software architecture for a system for query and index optimization for retrieving data in instances of a formulation data structure from a database;

FIG. 4 is an exemplary formulation record expressed in XML;

FIG. 5 is a flow chart illustrating an exemplary method for query and index optimization for retrieving data in instances of a formulation data structure from a database;

FIG. 6 is an exemplary display of alternate-search statistics;

FIG. 7 is an exemplary Venn diagram displaying alternate-search information;

FIG. 8A is an exemplary analysis table;

FIG. 8B is an exemplary analysis pie chart;

FIG. 9 is exemplary information that may be derived from field entries, stored as formulation data in an instance of a formulation data structure or other structured data, searched for by a user, and/or displayed to a user in a search result;

FIG. 10 is an exemplary display of a browser;

FIG. 11 is another exemplary display of a browser; and

FIG. 12 is a system for query and index optimization for retrieving data in instances of a formulation data structure from a database.

### DESCRIPTION OF THE EMBODIMENTS

The present disclosure describes systems and methods for query and index optimization for retrieving data in instances of a formulation data structure from a database. The systems and methods for query and index optimization for retrieving data in instances of a formulation data structure from a database may be used by commercial, government, and academic entities, including but not limited to scientists, intellectual property professionals, legal professionals, business professionals, patent-office examiners, regulatory bodies, and academics. The systems and methods may use a formulation data structure and a database engine that, along with an application (e.g., a web-enabled service), may enable specific fielded and structured search capabilities across information sources containing formulations, including formulations from the field of chemistry or other fields such as agrochemicals, pharmaceuticals, biotechnology, life sciences, manufacturing, cosmetics, health, food and beverage, consumer goods, paints, coatings, polymers, plastics, rubber, petroleum, gas, metals, alloys, cement, automotive, aerospace, and defense. At least one component of the system may enable collection of structured data and other data extracted from existing information sources to build a searchable digest using search-engine technology (e.g., using an offline architecture). At least one component of the system may enable a user to perform searches in a searchable digest (e.g., using an online architecture).

The systems and methods may be implemented as one or more web-enabled software applications for performing a search query for formulations or information sources that contain information on formulations. The systems and methods may be implemented as one or more application-programing interfaces for performing a search query for formulations or information sources that contain information on formulations. The systems and methods may be implemented as one or more database schemas or designs for performing a search query for formulations or information sources that contain information on formulations.

Reference will now be made in detail to exemplary embodiments, examples of which are illustrated in the accompanying drawings and disclosed herein. Whenever convenient, the same reference numbers will be used throughout the drawings to refer to the same or like parts.

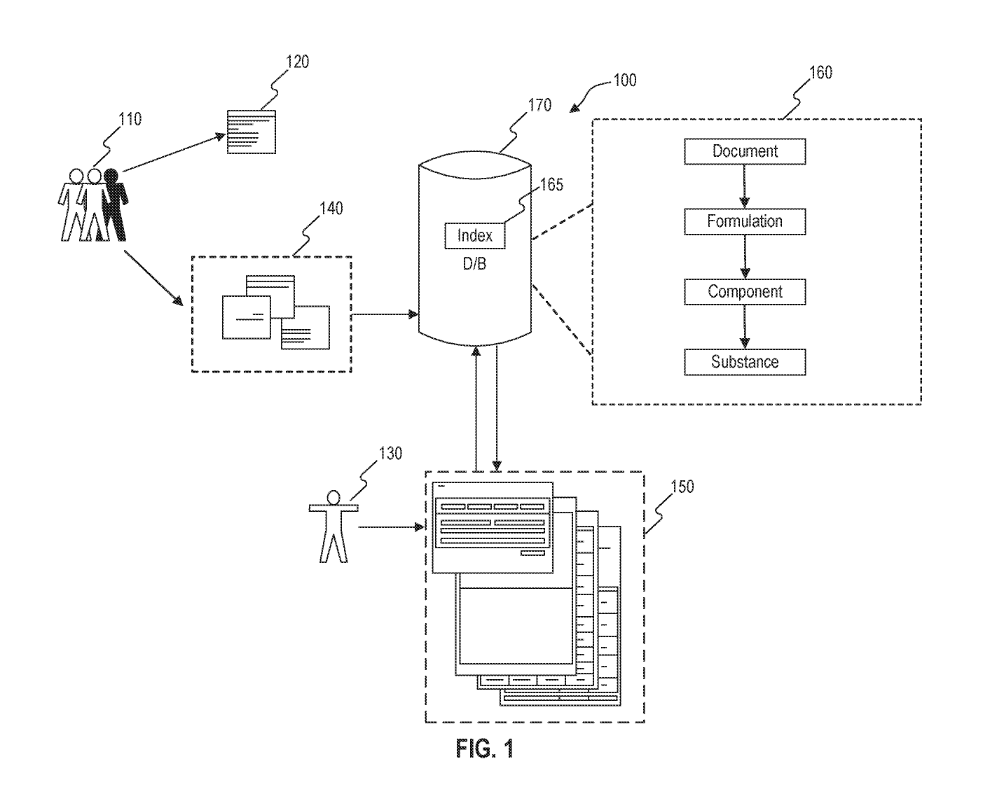

FIG. 1 illustrates an exemplary information flow diagram 100 for query and index optimization for retrieving data in instances of a formulation data structure from a database. In certain embodiments, a human or group of humans 110 with relevant technical knowledge may review information sources or published works 120 that a user 130 may want to search for formulations, formulation information, or other information. Human 110 may be, for example, a curator, indexer, and/or scientist. In some embodiments, an automated system may perform the review instead of or in addition to human 110. Human 110 may fill out a fielded electronic form 140 that may describe one or more information sources 120 that human 110 reviews. Human 110 may fill out one or more forms 140 with information derived from information source 120 and generate field entries that may be later used to facilitate formulation or information-source searches with a formulation search tool 150. Structured data, such as an instance of a formulation data structure (“formulation record 160”) associated with one or more formulations identified from the field entries, may be generated. The structured data may associate the one or more formulations with the information source where human 110 found the formulation. The structured data for one or more formulations may be indexed in an index 165. Index 165 may be an optimized index for searching for the structured data. The structured data and/or the index may be stored in a database 170. Index 165 may comprise a mapping between information derived from the field entries and stored in formulation record 160 and the one or more formulations associated with the information in these field entries. User 130 may search for the information derived from the field entries and stored in formulation record 160 by running a search query across the index or a binary digest generated from the index. The search engine may return one or more formulations identified by the information derived from field entries and stored in formulation record 160. In certain embodiments, instead of or in addition to one or more formulations, the search engine may return one or more information sources containing information on formulations identified by the information derived from field entries. In some embodiments, returning an information source may comprise providing information about the information source, such as its title, author, where the information source may be found, and/or a hyperlink to the information source. In certain embodiments, information sources may be stored as structured data.

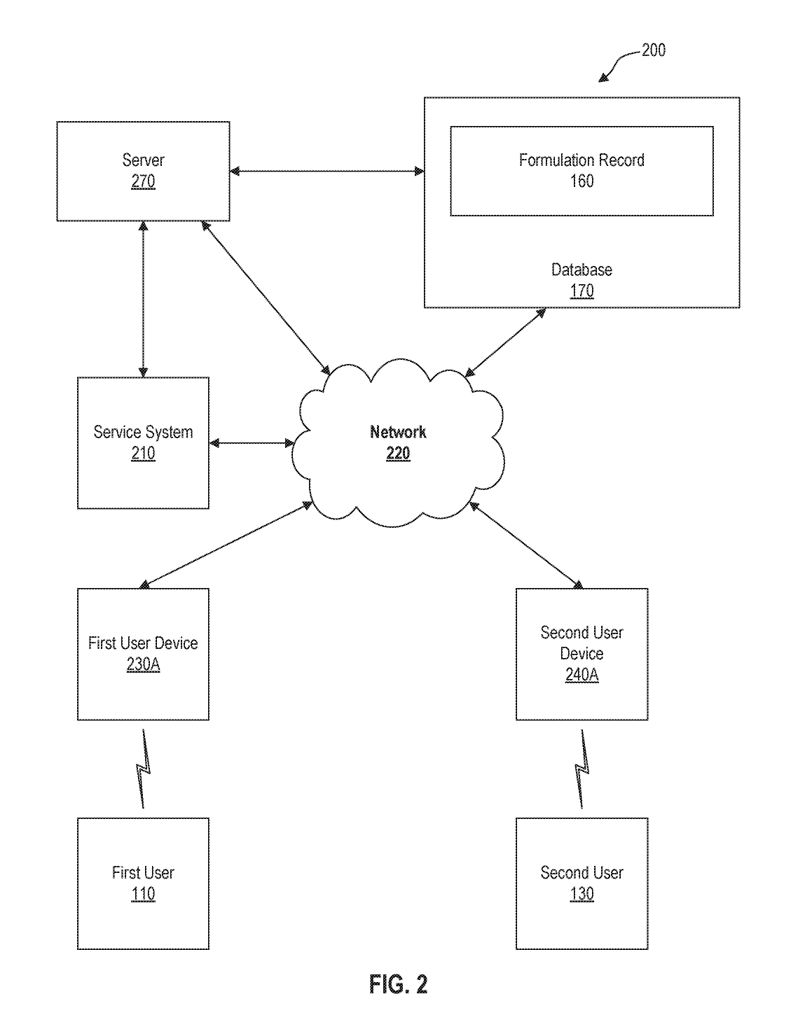

FIG. 2 illustrates an exemplary system environment 200 in which a system for query and index optimization for retrieving data in instances of a formulation data structure from a database may operate. The environment may comprise a service system 210, a network 220, user devices such as first user device 230A and second user device 240A, and users such as first user 110 and second user 130. The environment may further comprise a server 270 and a database 170 comprising formulation record 160 or instances of another type of structured data. Formulation record 160 may be expressed using a structured markup programming language such as Extensible Markup Language (XML). In some embodiments, database 170 may comprise optimized index data. Service system 210, database 170, and/or other computing systems are configured to receive information from entities in network 220, process the information, and communicate the information with other entities in the network 220, such as first user 110 and second user 130. For example, the service system 210 may be configured to receive data over an electronic network 220 (e.g., the Internet), process/analyze queries and data, and provide an application to users 110 and 130. This may be done over devices 230A and 240A.

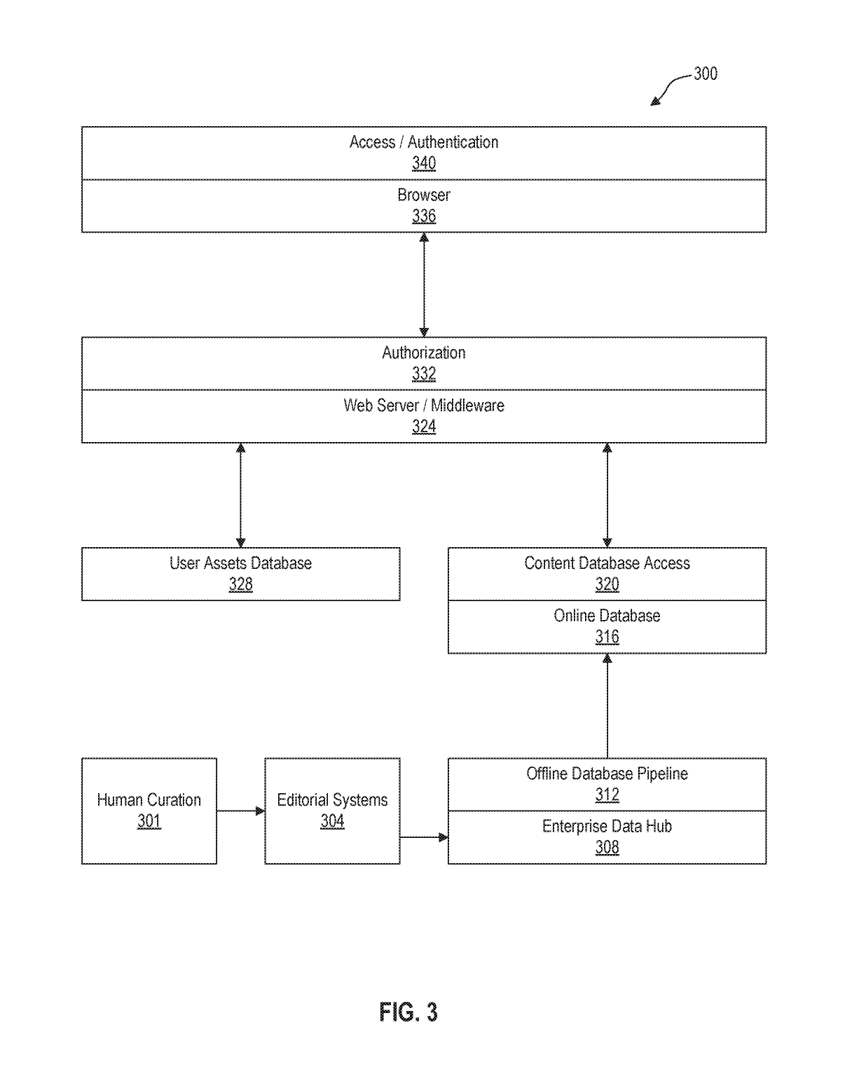

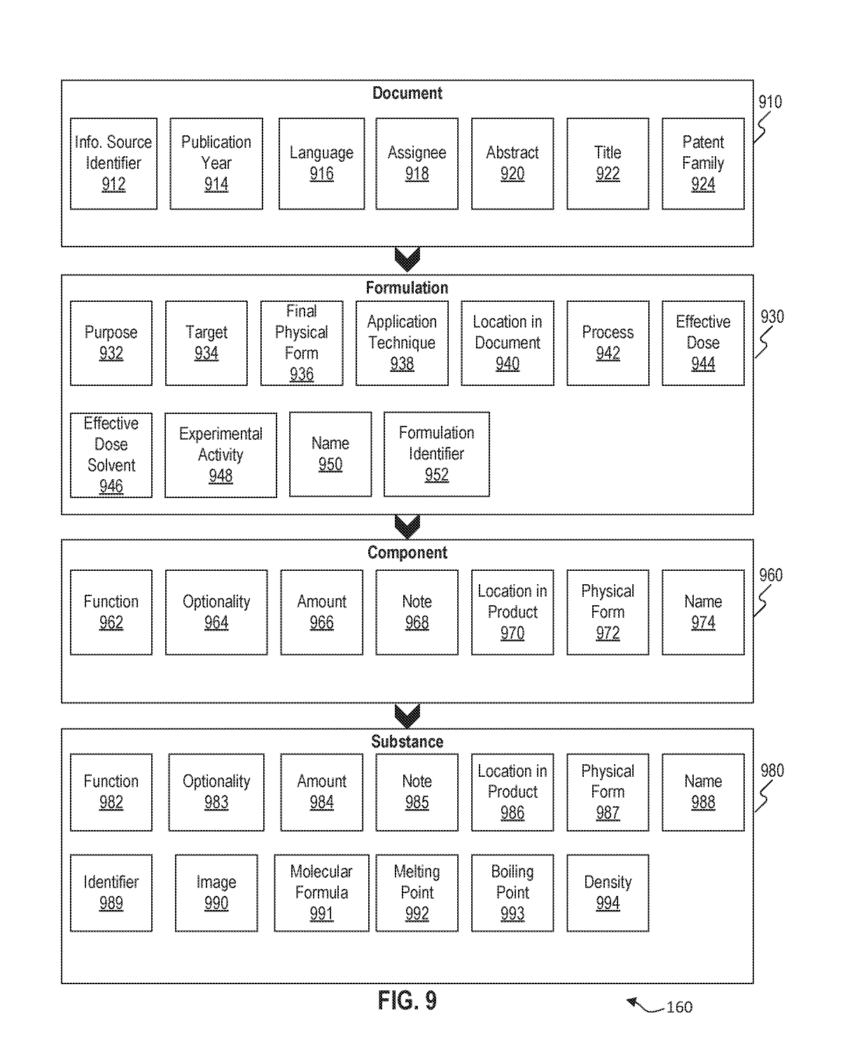

FIG. 3 illustrates an exemplary software architecture 300 for a system for query and index optimization for retrieving data in instances of a formulation data structure from a database. The system may provide a user 130 with access to a web application for searching for a formulation or information sources using a formulation database. A human curation component 301 may provide an interface for human 110 to analyze associated formulations and information sources. Human curation component 301 may provide human 110 with one or more electronic forms 140 with fields (e.g., a fielded form) that human 110 may fill out as they review information source 120, before they review information source 120, or after they review information source 120. Forms 140 may contain fields requesting information pertaining to formulations that human 110 finds in information source 120. This information may be any piece of information, such as those described below with respect to the exemplary information illustrated in FIG. 9 or information from which the exemplary information illustrated in FIG. 9 may be derived. For example, form 140 may have a field for entering the name of a substance. Later, the system may use the entered name to derive other information, such as the boiling point of the substance. The human curation component 301 may process forms 140 to generate formulation data from the field entries in form 140. Editorial systems 304 may process the formulation data to generate structured data (e.g., formulation record 160). The structured data may associate the one or more formulations with one or more information sources (e.g., information source 120) within which the one or more formulations was found by human 110. The structured data may be expressed using a structured markup programming language such as XML.

The structured data (e.g., formulation record 160) may be stored in enterprise data hub 308 and processed in the offline database pipeline 312. Enterprise data hub 308 may be a computer-readable storage medium or memory. In the offline database pipeline 312, one or more formulation records 160 expressed as structured data may be processed to generate index 165. Index 165 may be an inverted index. Index 165 may be a mapping between one or more potential search terms and formulation records 160. The formulation record 160 pointed to by the potential search terms in the index 165 may specify which information source a particular formulation was found in. Index 165 may contain potential search terms grouped based on a predicted access pattern. For example, if a particular search field accepts substance boiling-point search-terms, index 165 may group potential search terms (e.g., 98 C, 100 C, 100 degrees Celsius, 100 degrees Celsius) together such that the search engine may look in the part of index 165 that pertains to boiling points rather than the entire index 165 or unrelated portions of index 165. Such structuring of index 165 may optimize searching because it may permit the search engine to search only in the relevant part of index 165 for a particular search term rather than the entire index 165. As another non-limiting example, the grouping may be performed by determining patterns in a user's searching and grouping in order to minimize the time necessary to perform similar searches in the future. For example, the index data in index 165 may be compiled in a manner that optimizes a known or predicted frequent-use case, such as a search for information sources that contain substances with particular functions. The index-compilation process may optimize such a search query. In some embodiments, index 165 may contain potential search terms that are not grouped together by the search field in which those terms may be entered. Index 165 may be encoded into a binary digest in offline database pipeline 312 and the digest may be stored as online database 316. Index 165 may be generated and encoded into a binary digest using a distributed computing framework such as Apache Hadoop and related software packages.

The binary digest may be an information access platform (IAP) digest as described in United States Patent Application Publication US 2014/0372448 A1 to Olson et al., published Dec. 18, 2014. United States Patent Application Publication US 2014/0372448 A1 to Olson et al., published Dec. 18, 2014, is incorporated herein by reference in its entirety. The digest in online database 316 may be searched by a search engine. The search engine may be implemented using an enterprise search platform such as Apache SoIr. References to searching within index 165 or looking up information in index 165 may be understood by those of ordinary skill in the art to comprise searching in the binary digest or in index 165. A content-database access component 320 may facilitate exchange of information between Web Server/Middleware 324 and online database 316. Content-database access component 320 may be a database management system. User assets database 328 may contain information particular to individual users 130. Such information may include, for example, authentication information, previous searches, frequently used substances, aliases to substances, annotations, substance aliases, a scratch pad for text captured by the user, user profile information, review delegation information, occupation, field of interest, and/or alert and notification information. Web Server & Middleware component 324 may facilitate communication between user's 130 web browser 336 and content-database access component 320. The web server portion of the Web Server & Middleware component 324 may accept and supervise requests from browser 336. These requests may be made using a network protocol such as Hypertext Transfer Protocol (HTTP). The middleware portion of Web Server & Middleware component 324 may comprise an application programming interface for accessing a database management system such as content-database access component 320. A web-based formulation-searching application may be accessed through web browser 336. In some embodiments, an access/authentication module 340 may prevent unauthorized access to the formulation-searching application by comparing provided credentials to those stored in user-assets database 328.

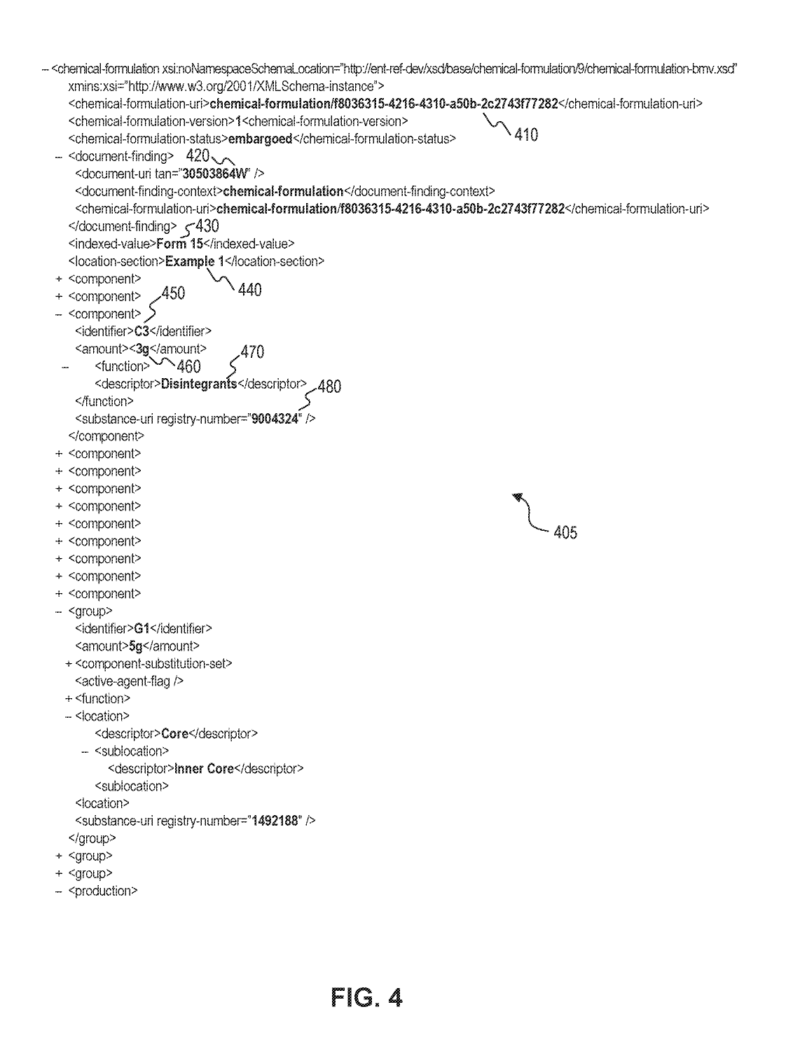

An exemplary portion of an exemplary formulation record 160 expressed in XML 405 is illustrated in FIG. 4. XML 405 may comprise a formulation uniform resource identifier 410. XML 405 may comprise a document number 420 that indicates an identifier of the information source in which the formulation identified with formulation number 410 was found. XML 405 may comprise an indexed value 430 indicating the information source indexed finding identifier, allowing a link to be created between the information source XML 420 and the indexed formulation data. XML 405 may comprise a location 440. Location 440 may indicate the location within the information source identified with document number 420 describing the formulation identified with formulation number 410. XML 405 may comprise a component identifier 450 that identifies a component within the formulation identified with formulation uniform resource identifier 410. XML 405 may comprise a component amount 460 identifying the amount of the component identified with component identifier 450. XML 405 may comprise a descriptor 470 describing the function of the component identified with component identifier 450. XML 405 may comprise a substance identifier 480, identifying a substance within the component identified with component identifier 450.

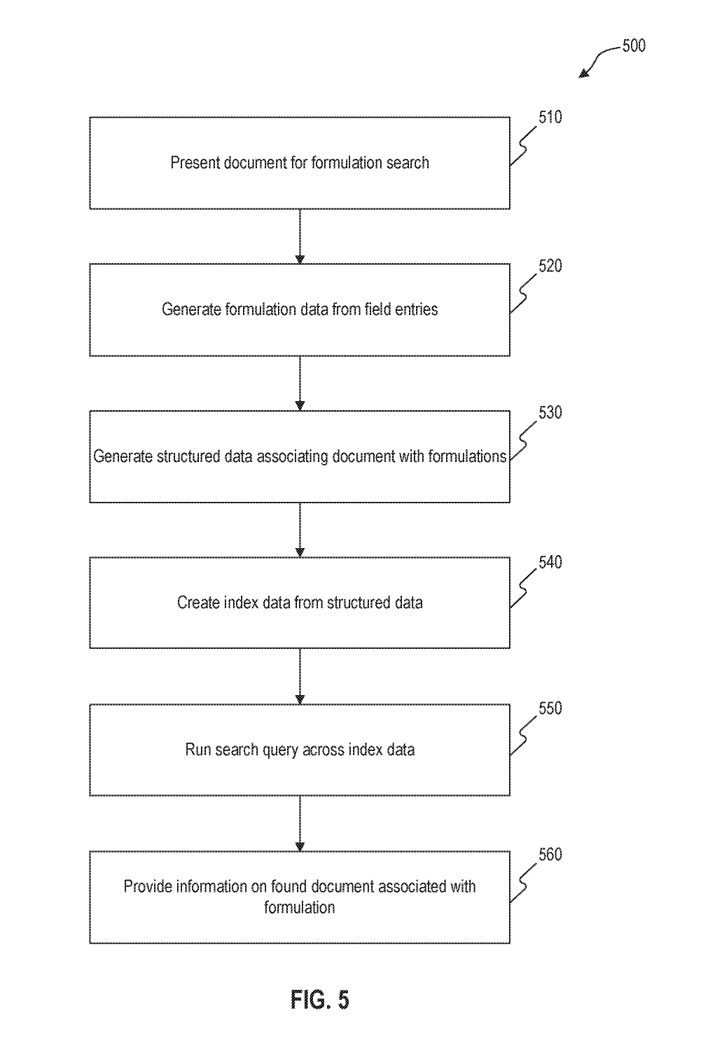

FIG. 5 is a flow chart illustrating an exemplary method 500 for query and index optimization for retrieving data in instances of a formulation data structure from a database. Method 500 may comprise presenting information source 120 for a formulation search at step 510. Information source 120 may be presented, for example, by human curation component 301 to human 110. Human 110 may populate form 140 with fielded entries. Form 140 may be populated by an automated system in addition to or instead of human 110. Method 500 may comprise generating formulation data from field entries at step 520. The formulation data may comprise component data associated with one or more components. For example, the one or more components may be those that are present in the formulation. The component data may comprise substance data associated with one or more substances. For example, the one or more substances may be those that are present in the component. The substance data may comprise one or more CAS Registry Numbers and/or other identifiers. The one or more CAS Registry Numbers or other identifiers may be unique identifiers for the substance. The formulation data may be stored until it is used to generate structured data such as formulation record 160. At step 530, method 500 may comprise generating structured data that associates one or more of the information sources 120 presented to human 110 with one or more formulations. The structured data may be generated by, for example, editorial system 304. The structured data may be, for example, an XML file (e.g., XML 405). Method 500 may comprise retrieving the data within the structured data and generating index data therefrom at step 540. Generating index data may comprise generating an optimized inverted index (e.g., index 165) and generating a binary digest from the inverted index. The binary digest may be generated in offline database pipeline 312. The index data may comprise a mapping between one or more potential search-field terms and the formulation data. The index data, such as the potential search terms within the inverted index, may be grouped by the search field in which the potential search terms may be entered (e.g., “Kelvin” and “Celsius” may be grouped together because they may be entered in the “boiling point” search field). Method 500 may comprise running an optimized search query across the index data at step 550. It is to be understood that the optimized search query may be run on the generated binary digest. The optimized search query may be generated from a request provided by user 130 and run by a search engine. Method 500 may comprise providing information pertaining to a found information source that is associated with a formulation at step 560. The information pertaining to a found information source associated with a formulation may be provided by, for example, content database access module 320. As an example, the search engine may find a match between the optimized search query and the potential search terms in the index data and information about a formulation or information source associated with the matched potential search terms according to the index data. If the index data points to formulation data from the matched potential search terms, the formulation data may point to the one or more information sources in which the pertinent formulation was found by human 110. Information about the formulation and/or the information source may be provided to user 130.

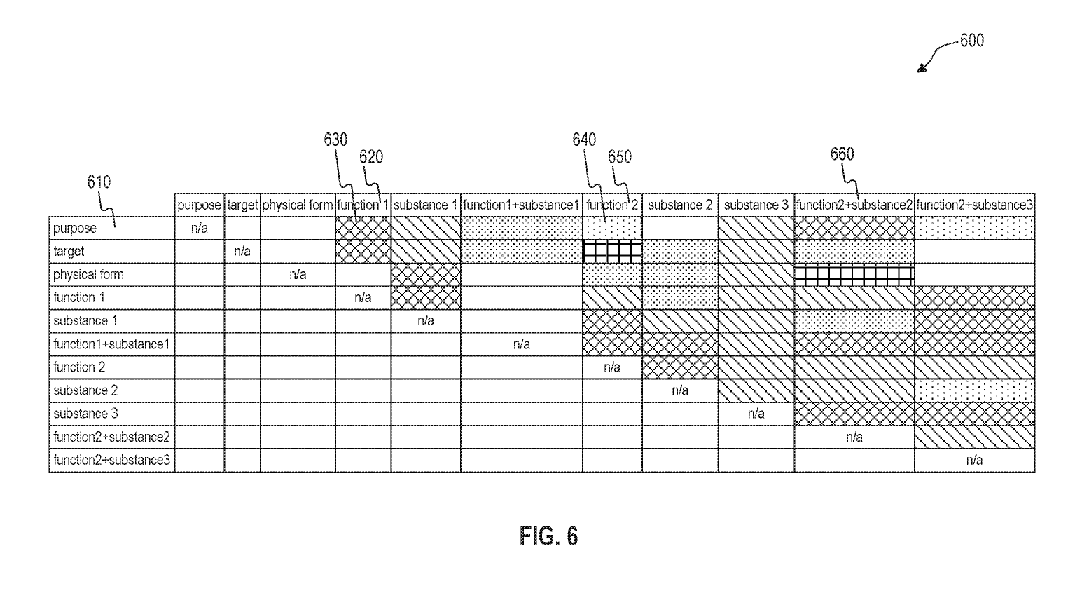

In certain embodiments, alternate-search statistics may be provided. Alternate-search statistics may provide user 130 with information about searches that differ from one or more searches user 130 previously ran. FIG. 6 illustrates an exemplary display 600 of alternate-search statistics. For example, the web application (e.g., formulation search tool 150) may suggest search terms for one or more fields (e.g., variables) to include in a search. Exemplary display 600 may display the list of suggested variables in a row, such as the “purpose” variable 610. The same or another list of suggested variables may be displayed in a column, such as “function 1” variable 620. The cell of display 600 that is in the row of a first variable and a column of a second variable may be shaded to represent the relative number of search results the user would get if they performed a search with the first and second variable. In some embodiments, a darker shaded cell may indicate that more search results would be found. For example, in display 600, the fact that cell 630 has darker shading than cell 640 may indicate that more search results will be found by searching using the “purpose” variable 610 and the “function 1” variable 620 suggested by the web application than by searching using the “purpose” variable 620 and “function 2” 650 variable. In certain embodiments, different color shading may provide more details about the alternate-search results. For example, green shading in a cell may indicate that a user will narrow their search using the variables indicated by the cell's row and column (e.g., the user will get fewer search results than in a previous search). Red shading in a cell may indicate that a user will expand their search using the variables indicated by the cell's row and column (e.g., the user will get more search results than in a previous search). User 130 may be able to select a cell to see the results of a search with the variables specified by the row and column of the selected cell. In some embodiments, the variables presented in display 600 may be those that are entered by user 130 instead of or in addition to those suggested by the web application. In some embodiments, display 600 may combine two variables into one row and/or column to maintain a two-dimensional table display while showing alternate-search information for more than two variables at a time. For example, column 660 may indicate the number of search results retrieved when using the “function 2” and the “substance 2” variable along with the variables in the left-most column. In an embodiment, a higher-dimensional structure than a two-dimensional table may be used to display alternate-search results.

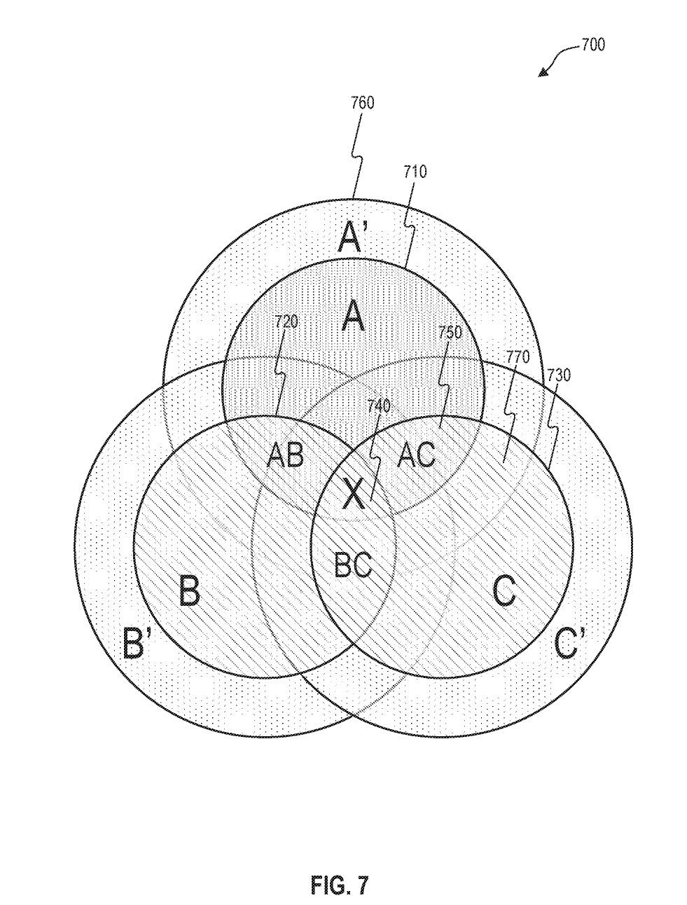

In certain embodiments, alternate-search information may be displayed in a Venn diagram such as exemplary Venn diagram 700 illustrated in FIG. 7. In Venn diagram 700, different variables suggested by the web application or specified by user 130 may be labeled with an indicator such as “A”, “B”, or “C”. Venn diagram 700 may contain a shape, such as circle A 710, circle B 720, and circle C 730, associated with one or more variables. The intersection 740 of all shapes (marked “X”) may provide information regarding the search results for a search comprising all entered or suggested variables. The web application may provide information on alternate searches by, for example, removing at least one of the user-specified variables and displaying the intersection of the remaining variables. For instance, the web application may perform a search by removing variable B and displaying the intersection 750 of the remaining variables A and C. User 130 may be presented with a number of search results associated with one or more alternate searches. Selecting an intersection of shapes associated with one or more variables may show the results of a search using those variables. For example, selecting the intersection 750 may display the results of a search using variables A and C. The web application may also suggest a broader search term than one specified by the variable (e.g., if the user sets a variable to “glucose,” the web application may suggest the broader term “sugar”). For example, the web application may do so by displaying a shape associated with variable A and label the shape “A′”. User 130 may be able to select the intersection of the broader variable, A′, and another variable, such as intersection 770 of A′ and C. In some embodiments, the web application may suggest variables representing terms that appear often within the same information sources that contain the searched variables. For example, if a variable representing the search term “Ascorbic Acid” is used in a search, the web application may suggest a search with the term “alpha-tocopherol”. In some embodiments, instead of in addition to suggesting search terms that frequently appear in the same information sources as those terms previously searched for, the web application may suggest search terms that frequently appear in the same formulations. In certain embodiments, the web application may determine whether to propose narrowing or broadening alternate searches by analyzing a user's history of searches and/or the results of a current search. For example, if the user has more than a threshold number of searches in a row that produce fewer results with each iteration, the web application may present a narrowing alternate search. If the user has more than a threshold number of searches in a row that produce more results with each iteration, the web application may present a broadening alternate search. In this or other manner, the web application may attempt to anticipate whether user 130 is looking to narrow his or her search or broaden it. As another non-limiting possibility in addition to or instead of the foregoing examples, the web application may present a broadening alternate search if the last search produced zero results or a narrowing alternate search if the last search produced more than a threshold number of results. The suggested alternate searches may depend on, for example, one or more settings in the user's profile, such as occupation or field of interest.

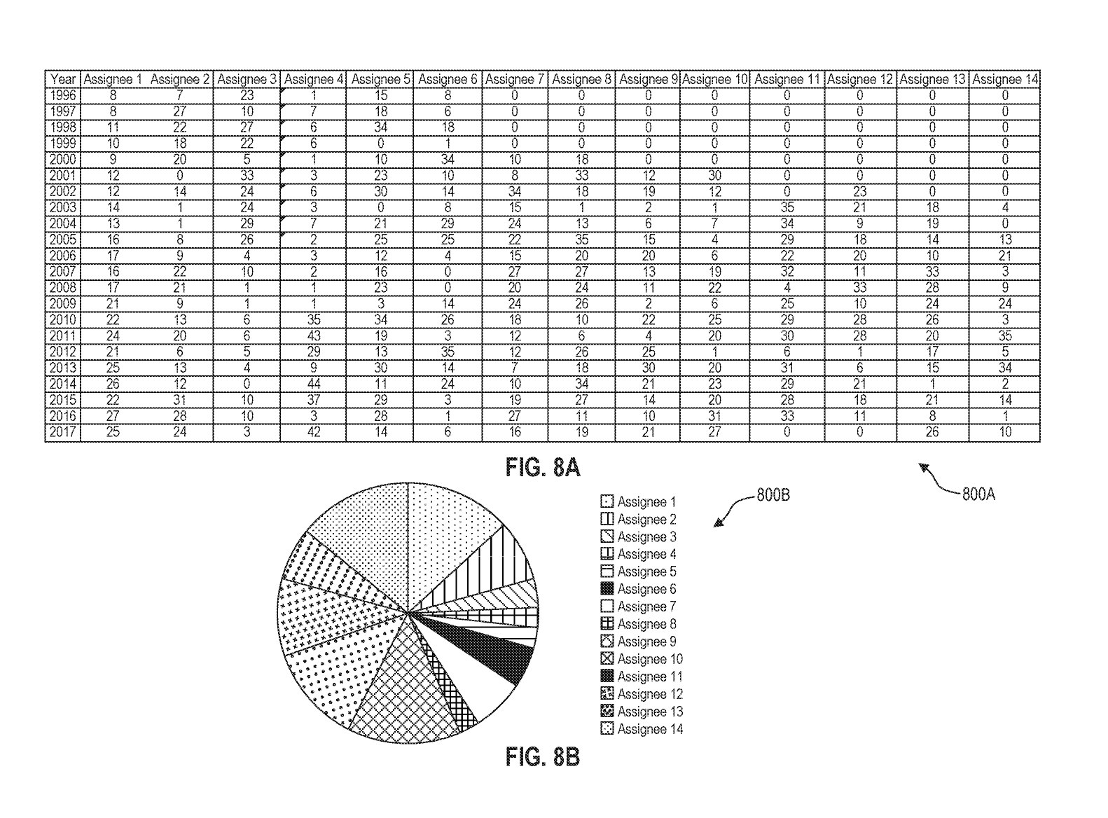

In some embodiments, user 130 may select two parameters of interest and build a table that shows the number of instances of one parameter that occur in instances of another parameter. For example, user 130 may select a parameter “Assignee” and a parameter “year.” The resulting exemplary analysis table 800A, as illustrated in FIG. 8A, may show how many patents were assigned to one or more assignees in one or more years. User 130 may select a particular row or column to view the data therein graphically, such as in exemplary pie chart 800B illustrated in FIG. 8B. Exemplary analysis pie chart 800B may indicate the relative numbers of patents assignees were assigned in a year selected by user 130.

FIG. 9 illustrates exemplary information that may be derived from field entries, stored as formulation data in an instance of a formulation data structure (e.g., formulation record 160) or other structured data, searched for by user 130, and/or displayed to user 130 in a search result. In some embodiments, this information may be structured in an instance of a formulation data structure comprising a four-layer entity hierarchy. The top layer may be document layer 910 and may contain information associated with information source 120 reviewed by human 110. The information associated with information source 120 may be at least one of an information source identifier 912, a publication year 914, a language 916, an assignee 918, an abstract 920, a title 922, or a patent family 924. In certain embodiments, information regarding an information source is stored in the database 170 if the information source contains one or more formulations 930. The information associated with the one or more formulations 930 may be at least one of their purpose 932, target 934, final physical form 936, application technique 938, location in the information source 940, process 942, effective dose 944, effective dose solvent 946, experimental activity 948, name 950, or formulation identifier 952. Formulation identifier 952 associated with formulation 930 may be an identifier for formulation 930, such as, for example, an alphanumeric or numeric identifier. In certain embodiments, a particular formulation identifier 952 may be associated with a single formulation 930. In certain embodiments, formulation 930 may comprise one or more components 960. The information associated with the one or more components 960 may comprise at least one of their function 962, their optionality 964, their amount 966, a note 968, a location in a product 970, their physical form 972, or their name 974. In some embodiments, component 960 may comprise one or more substances 980. The information associated with the one or more substances 980 may comprise at least one of their function 982, their optionality 983, their amount 984, a note 985, their location in a product 986, their physical form 987, their name 988, their identifier 989, their image 990, their molecular formula 991, their melting point 992, their boiling point 993, or their density 994. The compartmentalization of data between the layers in formulation record 160 may be reflected in the formulation data structure. In some embodiments, other structures and compartmentalization may be used.

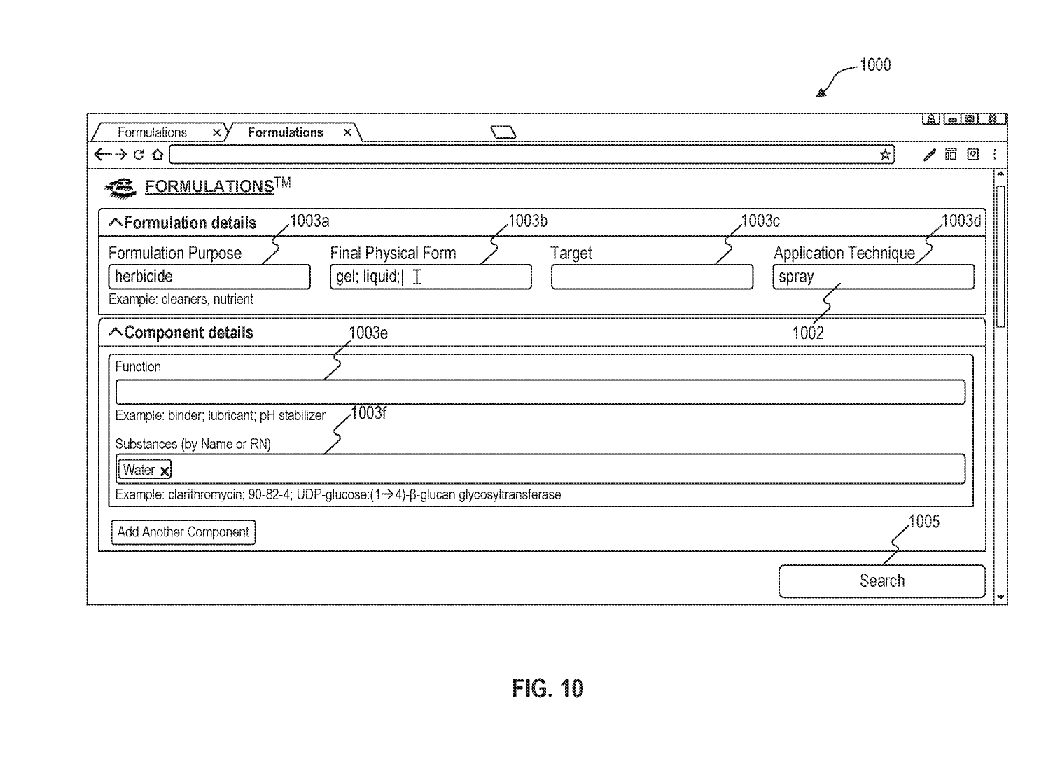

FIG. 10 illustrates an exemplary display 1000 of browser 336. User 130 may enter various search terms, such as search term 1002, in search fields such as search fields 1003a-f. Some possible search fields may include, but are not limited to, at least one of a formulation purpose, a final physical form, a target, an application technique, a function, or a substance. A search may be initiated by selecting a search selector 1005. Search terms within a single field may be separated by, for example, a character (e.g., a semi-colon). The character may determine the Boolean logic used for creating the search query. The search fields may be grouped into categories, such as a group for formulation details, a group for component details, and/or a group for substance details. A search may include one or more components for a formulation and/or one or more substances for a formulation. Additional possible search fields are discussed above with respect to FIG. 9.

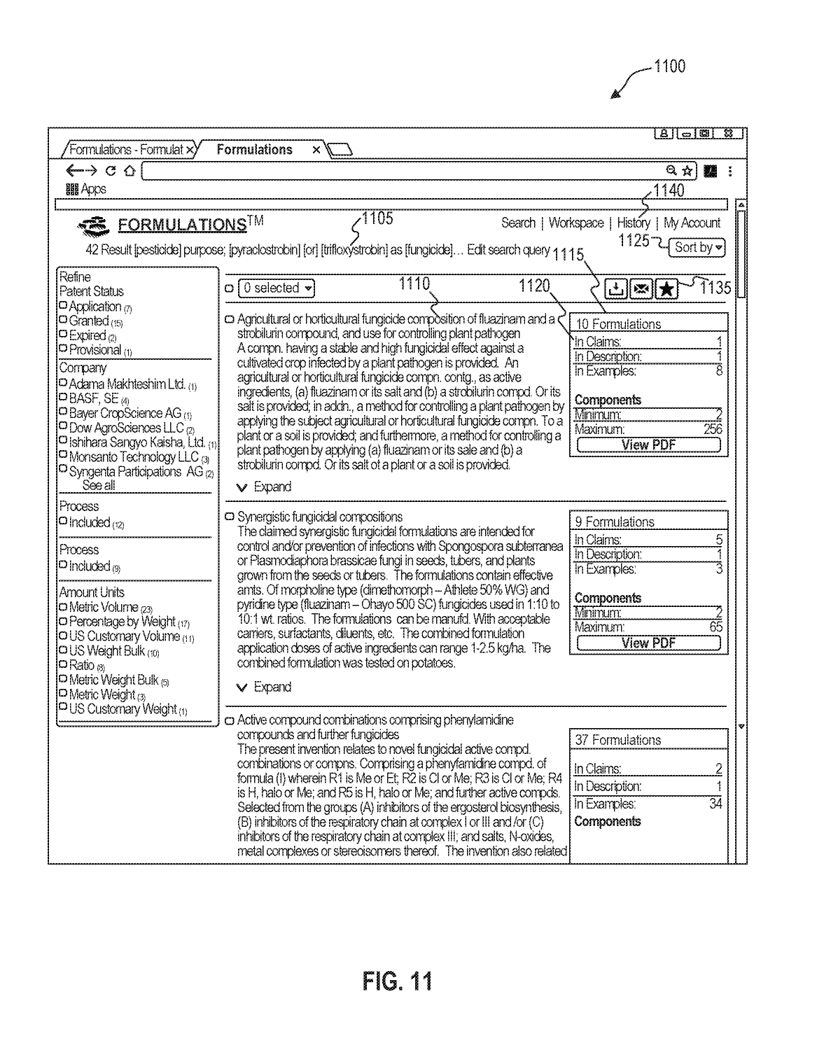

FIG. 11 illustrates another exemplary display 1100 of browser 336. A search query 1105 derived from search terms entered by user 130 may be displayed with information source 1110 as a search result. The information source's title, abstract, and/or summary may be displayed. The number of formulations found in the information source may be displayed in a formulation-summary window 1115. Formulation-summary window 1115 may also display where in the information source the formulations are disclosed (e.g., in the claims, in examples, etc.) as summary information 1120. User 130 may sort the information sources presented in the search results with sort selector 1125. The information sources may be sorted, for example, by relevance. Relevance may be determined in at least one manner known to those of ordinary skill in the art. In some embodiments, relevancy may be determined by one or more settings in the user's profile, such as occupation or field of interest. In some embodiments, the location in which a formulation, component, or substance appears in an information source may partially or fully determine the information source's relevancy. For example, if a formulation appears in a patent's claim, the information source may be assigned a higher relevancy than if the formulation appears in a patent's specification. This or other systems of weighting may be used to assign relevancy. The information sources presented as search results may be filtered using a filter selector 1130. Filter selector 1130 may allow filtering by one or more parameters, such as a company that produced an information source. User 130 may select an alerts or notification feature 1135 that will update or notify user 130 when the search for which search results are currently displayed produces different results. User 130 may see their search history by selecting history feature 1140. User 130 may rerun his or her previous searches or set alerts or notifications for previous searches.

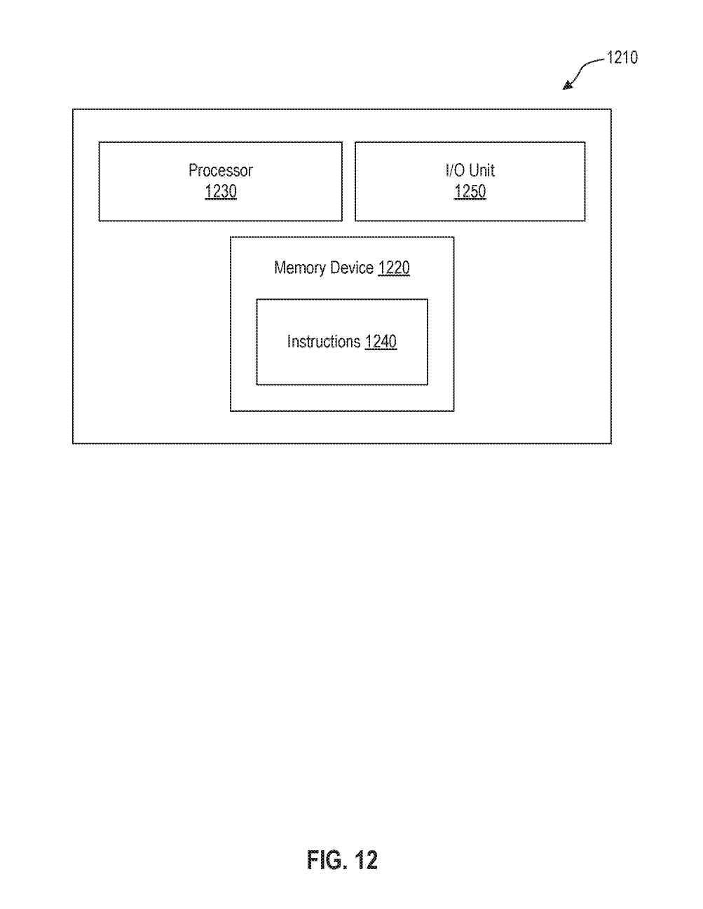

A system for query and index optimization for retrieving data in instances of a formulation data structure from a database is illustrated in FIG. 12 as exemplary system 1210. The various components of system 1210 may include an assembly of hardware, software, and/or firmware, including a memory device 1220, a central processing unit (“CPU”) with one or more processors 1230, and/or an optional user interface unit (“I/O Unit”) 1250. Memory device 1220 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. The one or more processors 1230 may process data according to a set of programmable instructions 1240 or software stored in the memory device 1220. The functions of each processor 1230 may be provided by a single dedicated processor 1230 or by a plurality of such processors. Moreover, the one or more processors 1230 may include, without limitation, digital signal processor (DSP) hardware, or any other hardware capable of executing software. I/O Unit 1250 may comprise any type or combination of input/output devices, such as a display monitor, keyboard, touch screen, and/or mouse. I/O Unit 1250 may receive search queries. The one or more processors 1230 may execute instructions 1240 causing the system to output formulation and/or information source data through the I/O Unit 1250.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various programs or program modules can be created using a variety of programming techniques. For example, program sections or program modules can be designed in or by means of Java™ (see https://docs.oracle.com/javase/8/docs/technotes/guides/language/), C, C++, assembly language, or any such programming languages. One or more of such software sections or modules can be integrated into a computer system, non-transitory computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A computer-implemented system for query and index optimization for retrieving data in instances of a formulation data structure from a database, comprising:
a memory device that stores a set of instructions; and
at least one processor that executes the set of instructions to perform a method, the method comprising:
presenting an information source for searching for the presence of one or more formulations;
generating formulation data from field entries, wherein the formulation data is associated with one or more found formulations;
generating an instance of a formulation data structure, wherein the instance of the formulation data structure associates the information source with the one or more found formulations;
creating optimized index data from retrieved data in the instance of the formulation data structure, wherein the optimized index data (i) comprises a mapping between one or more potential search-field terms and the formulation data, and (ii) is grouped based on a predicted access pattern;
running a search query across the optimized index data; and
providing information associated with a found information source associated with retrieved data in an instance of a formulation data structure.

2. The system of claim 1, wherein the optimized index data is an inverted index.

3. The system of claim 1, wherein the optimized index data is grouped based on a predicted access pattern such that a search engine's access time of the optimized index data is decreased.

4. The system of claim 1, wherein the formulation data comprises component data associated with one or more components.

5. The system of claim 4, wherein the component data comprises substance data associated with one or more substances.

6. The system of claim 5, wherein the substance data comprises at least one of a registry number, an identifier, a chemical connection table, a structure diagram, or a specific numeric property value.

7. The system of claim 1, wherein the method further comprises presenting alternate-search statistics.

8. The system of claim 1, wherein the method further comprises assigning a relevancy weight to the found information source.

9. The system of claim 1, wherein the search query comprises one or more search terms associated with one or more search fields.

10. The system of claim 9, wherein the one or more search fields pertain to a scientific field.

11. The system of claim 1, wherein the one or more formulations are chemical formulations.

12. The system of claim 1, wherein the retrieved data in an instance of the formulation data structure associated with the found information source is associated with a formulation identifier.

13. A non-transitory computer-readable medium storing a set of instructions that are executable by at least one processor to perform a method for query and index optimization for retrieving data in instances of a formulation data structure from a database, the method comprising:
presenting an information source for searching for the presence of one or more formulations;
generating formulation data from field entries, wherein the formulation data is associated with one or more found formulations;
generating an instance of a formulation data structure, wherein the instance of the formulation data structure associates the information source with the one or more found formulations;
creating optimized index data from retrieved data in the instance of the formulation data structure, wherein the optimized index data (i) comprises a mapping between one or more potential search-field terms and the formulation data, and (ii) is grouped based on a predicted access pattern;
running a search query across the optimized index data; and
providing information associated with a found information source associated with retrieved data in an instance of a formulation data structure.

14. The non-transitory computer-readable medium of 13, wherein the optimized index data is an inverted index and is grouped based on a predicted access pattern such that a search engine's access time of the optimized index data is decreased.

15. The non-transitory computer-readable medium of claim 13, wherein the formulation data comprises component data associated with one or more components, and the component data comprises substance data associated with one or more substances.

16. The non-transitory computer-readable medium of claim 15, wherein the substance data comprises at least one of a registry number, an identifier, a chemical connection table, a structure diagram, or a specific numeric property value.

17. The non-transitory computer-readable medium of claim 13, wherein the method further comprises presenting alternate-search statistics and assigning a relevancy weight to the found information source.

18. The non-transitory computer-readable medium of claim 13, wherein:
the search query comprises one or more search terms associated with one or more search fields;
the one or more search fields pertain to a scientific field; and
the one or more formulations are chemical formulations.

19. The non-transitory computer-readable medium of claim 13, wherein the retrieved data in an instance of the formulation data structure associated with the found information source is associated with a formulation identifier.

20. A method for query and index optimization for retrieving data in instances of a formulation data structure from a database, the method comprising:
presenting an information source for searching for the presence of one or more formulations;
generating formulation data from field entries, wherein the formulation data is associated with one or more found formulations;
generating an instance of a formulation data structure, wherein the instance of the formulation data structure associates the information source with the one or more found formulations;
creating optimized index data from retrieved data in the instance of the formulation data structure, wherein the optimized index data (i) comprises a mapping between one or more potential search-field terms and the formulation data, and (ii) is grouped based on a predicted access pattern;
running a search query across the optimized index data; and
providing information associated with an information source associated with retrieved data in an instance of a formulation data structure.
